(19) United States
(12) Patent Application Publication
(10) Pub. No.: US 2013/0151668 A1
(43) Pub. Date: Jun. 13, 2013

(54) SYSTEM AND METHOD FOR MANAGING RESOURCE WITH DYNAMIC DISTRIBUTION

(71) Applicant: GUANG-JIAN WANG, Shenzhen City (CN)

(72) Inventor: GUANG-JIAN WANG, Shenzhen City (CN)

(21) Appl. No.: 13/661,325

(22) Filed: Oct. 26, 2012

(30) Foreign Application Priority Data
Dec. 8, 2011 (CN) 201110405794.6

(51) Int. Cl. G06F 15/16

(52) U.S. Cl. 709/219

(57) ABSTRACT

A method to dynamically redistributes guest OSes in a data center using a remote server. The remote server searches for one or more guest OSes from the host OS, if the obtained CPU utilization percentage of the host OS exceeds a predetermined CPU utilization percentage. The remote server redistributes all of the guest OS in the data center using a knapsack algorithm, if no other host OS is capable of receiving the one or more searched guest OSes. The remote server transfers the one or more searched guest OSes to other host OS if the other host OS is capable of receiving the one or more searched guest OSes.

### BACKGROUND

1. Technical Field

Embodiments of the present disclosure relate to virtualization technology, and particularly to a system and method for managing resource with dynamic distribution.

2. Description of Related Art

A guest operating system (OS) runs in a virtualized environment. The virtualized environment virtualizes a personal computer or a server on an OS kernel layer. By using the virtualized environment, multiple guest OS can co-exist and run independently on the same computer. Each guest OS may use processing time of a CPU of a computer, which is measured by a CPU utilization percentage of the CPU (e.g., 60% capacity usage of a CPU). A summation of the CPU utilization percentage of all guest OSes in the computer is less than a predetermined threshold (e.g., 85%) when the computer works normally. In such a situation, the computer has a redundancy of the CPU utilization percentage. For example, the summation of the CPU utilization percentages of all guest OSes may be 60%, and the redundancy of the CPU utilization percentage is 25%. Thus the CPU may be under-utilized some of the time. Therefore, there is room for improvement in the art.

### BRIEF DESCRIPTION OF THE DRAWINGS

FIG. 1 is a system view of one embodiment of a resource dynamic distribution system.

FIG. 2 is a block diagram of one embodiment of a remote server included in the resource dynamic distribution system of FIG. 1.

FIG. 3 is a flowchart of one embodiment of a resource dynamic distribution method.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

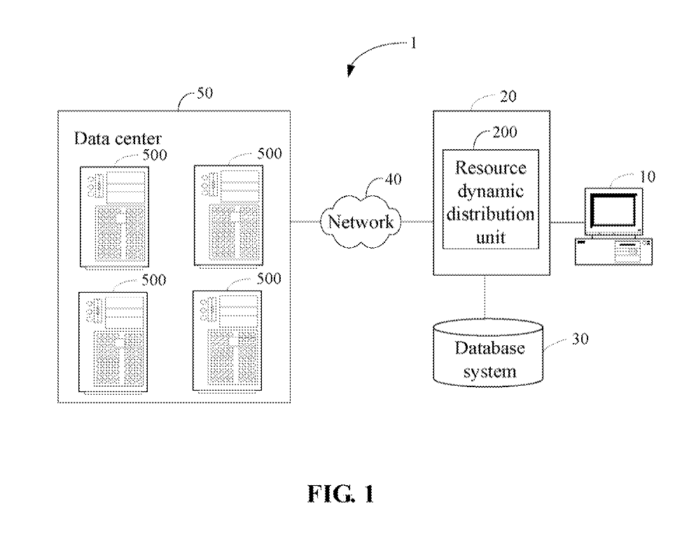

FIG. 1 is a system view of one embodiment of a resource dynamic distribution system 1. In one embodiment, the resource dynamic distribution system 1 may include a remote server 20 and a data center 50. The data center 50 is designed for cloud computing capability, and includes a plurality of cloud servers 500. The remote server 20 is connected to one or more client computers 10, and connected to the data center 50 via a network 40. The network 40 may be a wide area network (e.g., the Internet) or a local area network. The resource dynamic distribution system 1 may be used to monitor a CPU utilization percentage of each cloud server 500. Using open database connectivity (ODBC) or JAVA database connectivity (JDBC), for example, the remote server 20 is connected to a database system 30. The database system 30 may store the central processing unit (CPU) utilization percentage, which is obtained by the remote server 20. Additionally, each client computer 10 provides an operation interface for controlling one or more operations of the remote server 20.

The cloud servers 500 also store the CPU utilization percentage. The CPU utilization percentage may show performance of the cloud servers 500 and be generated by the cloud servers 500 themselves when the cloud servers 500 run. Additionally, the cloud servers 500 may store a serial number of each cloud server 500, a voltage of each cloud server 500, a rotational speed of a fan of each cloud server 500, a temperature of each cloud server 500, a status of each cloud server 500 (e.g., power on/off), a memory utilization percentage of each cloud server 500, a disk utilization percentage of each cloud server 500, and a network traffic of each cloud server 500.

Each cloud server 500 is installed with a host operating system (OS). The host OS is a platform for one or more guest OSes and installed with the one or more guest OSes. The CPU utilization percentage of the host OS is equal to a summation of the CPU utilization percentages of the one or more guest OSes. For example, if the host OS is installed with ten guest OS, the CPU utilization percentage of the host OS is equal to a summation of the CPU utilization percentages of the ten guest OSes. In order to manage the one or more guest OSes, each cloud server 500 is installed with a virtual machine management application (e.g., HYPERVISOR). HYPERVISOR is used to manage and monitor operations of the one or more guest OSes. HYPERVISOR also obtains the CPU utilization percentage of each guest OS from each cloud server 500.

The remote server 20, in one example, can be also a dynamic host configuration protocol (DHCP) server. The remote server 20 is installed with a DHCP service. In one embodiment, the remote server 20 assigns Internet protocol (IP) addresses to the cloud servers 500 by the DHCP service. In one embodiment, the remote server 20 uses dynamic allocation to assign the IP addresses to the cloud servers 500. For example, when the remote server 20 receives a request from a cloud server 500 via the network 40, the remote server 20 dynamically assigns an IP address to the cloud server 500. In one embodiment, the remote server 20 may be a personal computer (PC), a network server, or any other data-processing equipment which can provide an IP address allocation function.

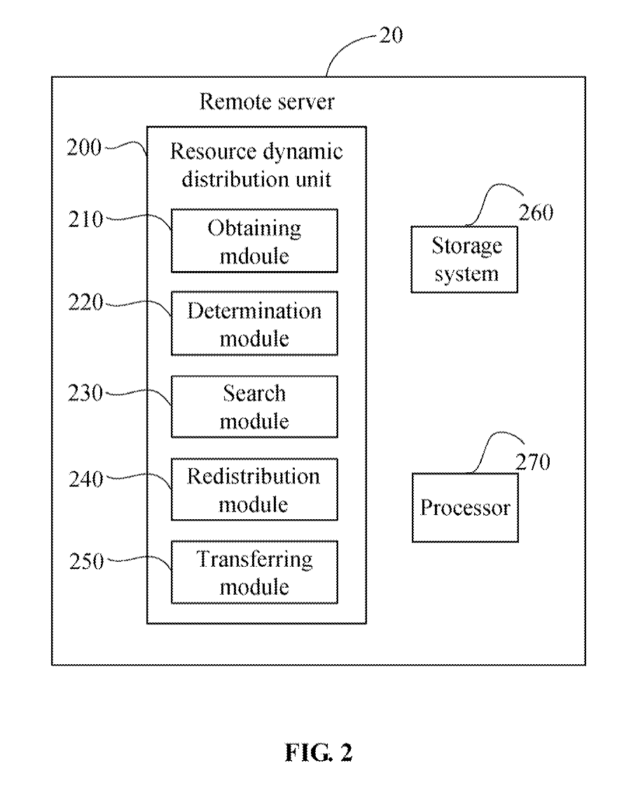

FIG. 2 is a block diagram of one embodiment of the remote server 20. The remote server 20 includes a resource dynamic distribution unit 200. The resource dynamic distribution unit 200 revises a CPU utilization percentage range of a host OS installed in the cloud server 500. The remote server 20 includes a storage system 260, and at least one processor 270. In one embodiment, the resource dynamic distribution unit 200 includes an obtaining module 210, a determination module 220, a search module 230, a redistribution module 240, and a transferring module 250. The modules 210-250 may include computerized code in the form of one or more programs that are stored in the storage system 260. The computerized code includes instructions that are executed by the at least one processor 270 to provide functions for the modules 210-250. The storage system 260 may be a memory device, such as an erasable programmable read only memory (EPROM), a hard disk drive (HDD), or a flash memory.

The obtaining module 210 obtains a CPU utilization percentage of each host OS from each cloud server 500. In one embodiment, the obtaining module 210 obtains the CPU utilization percentage of the host OS from HYPERVISOR installed in the cloud server 500. The obtained CPU utilization percentage may be a percentage capacity usage of the CPU. In additions, the obtaining module 210 obtains the CPU utilization percentage from HYPERVISOR at intervals (e.g., every hour). Even if the cloud server 500 freezes up, the obtaining module 210 may still obtain the CPU utilization percentage of each host OS installed in the cloud server 500. If the cloud server 500 freezes up, the CPU utilization percentage of the host OS installed in the cloud server 500 is 100%.

The determination module 220 determines if the obtained CPU utilization percentage of the host OS exceeds a predetermined CPU utilization percentage. In one embodiment, the predetermined CPU utilization percentage may be set as 85%, for example.

The search module 230 searches for one or more guest OSes from the host OS, if the obtained CPU utilization percentage of the host OS exceeds the predetermined CPU utilization percentage. The search module 230 obtains the CPU utilization percentage of each guest OS from the host OS in a descending order. The search module 230 searches for one or more guest OSes and calculates a summation of the CPU utilization percentage of one or more guest OSes in the descending order. If the CPU utilization percentage of the host OS minus a summation of the CPU utilization percentage of the one or more guest OSes is equal to or less than the predetermined CPU utilization percentage, the search module 230 stops searching.

The determination module 220 determines if other host OS is capable of receiving the one or more searched guest OSes. In one embodiment, the determination module 220 checks if a redundancy of the CPU utilization percentage of the other host OS is equal to or greater than a summation of the CPU utilization percentage of the one or more searched guest OSes. If the redundancy of the CPU utilization percentage of the other host OS is equal to or greater than the summation of the CPU utilization percentages of the one or more searched guest OSes, then the other host OS is deemed to be capable of receiving the one or more searched guest OSes. In addition, the redundancy of the CPU utilization percentage of the other host OS is equal to the predetermined CPU utilization percentage minus the CPU utilization percentage of the other host OS. For example, if the CPU utilization percentage of the other host OS is 60%, and the predetermined CPU utilization percentage is set as 85%, then the redundancy of the CPU utilization percentage of the other host OS is 25%.

The redistribution module 240 redistributes all of the guest OS in the data center using a knapsack algorithm, if no other host OS is capable of receiving the one or more searched guest OSes. The redistribution module 240 redistributes all of the guest OS in the data center, in order to reduce the redundancy of the CPU utilization percentage of each host OS.

The transferring module 250 transfers the one or more searched guest OSes to other host OS if the other host OS is capable of receiving the one or more searched guest OSes. In one embodiment, the transferring module 250 invokes HYPERVISOR to transfer the one or more guest OSes.

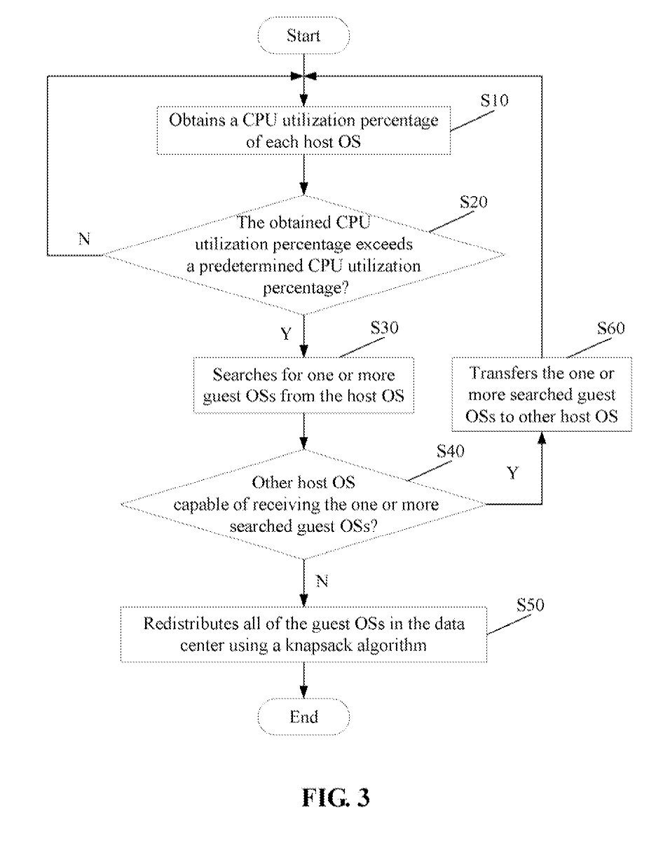

FIG. 3 is a flowchart of one embodiment of a resource dynamic distribution method. Depending on the embodiment, additional steps may be added, others deleted, and the ordering of the steps may be changed.

In step S10, the obtaining module 210 obtains a CPU utilization percentage of each host OS from each cloud server 500. As mentioned above, the obtaining module 210 obtains the CPU utilization percentage from HYPERVISOR at an interval (e.g., every hour). For example, the data center 50 includes four cloud servers 500, and each cloud server is installed with one host OS and one HYPERVISOR. The obtaining module 210 obtains four CPU utilization percentages of the host OS from the four cloud servers 500.

In step S20, the determination module 220 determines if the obtained CPU utilization percentage of the host OS exceeds a predetermined CPU utilization percentage. In one embodiment, if the predetermined CPU utilization percentage has been set as 85%, for example, the data center 50 includes four cloud servers 500, one of the four CPU utilization percentages is 88%, the procedure goes to step S30. Otherwise, if all of the four CPU utilization percentages are less than or equal to 85%, the procedure returns to step S10.

In step S30, the search module 230 searches the host OS with the CPU utilization percentage exceeding the predetermined CPU utilization percentage for one or more guest OSes with high CPU utilization percentage. For example, assuming that the host OS includes five guest OS (e.g., A, B, C, D and F), the CPU utilization percentage of the host OS is 89%, wherein the CPU utilization percentage of the guest OS A is 20%, the CPU utilization percentage of the guest OS B is 25%, the CPU utilization percentage of the guest OS C is 10%, the CPU utilization percentage of the guest OS D is 18%, and the CPU utilization percentage of the guest OS F is 16%. The search module 230 searches for the guest OS B first, and calculates that the CPU utilization percentage of the host OS minus the CPU utilization percentage of the guest OS B is less than 85%, the search module 230 stops searching.

In step S40, the determination module 220 determines if other host OS is capable of receiving the one or more searched guest OSes. In one embodiment, if the redundancy of the CPU utilization percentage of the other host OS is 25%, the summation of the CPU utilization percentages of the one or more searched guest OSes is 20%, the procedure goes to step S60. Otherwise, if the redundancy of the CPU utilization percentage of the other host OS is 18%, the procedure goes to step S50.

In step S50, the redistribution module 240 redistributes all of the guest OS in the data center 50 using a knapsack algorithm, if no other host OS is capable of receiving the one or more searched guest OSes. As mentioned above, the redistribution module 240 redistributes all of the guest OS in the data center 50, in order to reduce the redundancy of the CPU utilization percentage of each host OS.

In step S60, the transferring module 250 transfers the one or more searched guest OSes to other host OS if the other host OS is capable of receiving the one or more searched guest OSes. As mentioned above, the transferring module 250 invokes HYPERVISOR to transfer the one or more guest OSes.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote server, the remote server in electronic communication with a plurality of cloud servers of a data center, the remote server comprising:
a storage system;
at least one processor; and
one or more programs stored in the storage system and being executable by the at least one processor, the one or more programs comprising:
an obtaining module obtains a central processing unit (CPU) utilization percentage of each host operating system (OS) from each cloud server;
a search module searches the host OS with the CPU utilization percentage exceeding the predetermined CPU utilization percentage for one or more guest OSes with high CPU utilization percentage;
a redistribution module redistributes all of the guest OS in the data center using a knapsack algorithm, if no other host OS is capable of receiving the one or more searched guest OSes; and
a transferring module transfers the one or more searched guest OSes to other host OS if the other host OS is capable of receiving the one or more searched guest OSes.

2. The remote server of claim 1, wherein the other host OS is capable of receiving the one or more searched guest OSes upon the condition that a redundancy of the CPU utilization percentage of the other host OS is equal to or greater than a summation of the CPU utilization percentages of the one or more searched guest OSes.

3. The remote server of claim 2, wherein the redundancy of the CPU utilization percentage of the other host OS is equal to the predetermined CPU utilization percentage minus the CPU utilization percentage of the other host OS.

4. The remote server of claim 1, wherein the obtaining module obtains the CPU utilization percentage of the host OS from a virtual machine management application installed in the cloud server.

5. The remote server of claim 4, wherein the transferring module transfers the one or more searched guest OSes using the virtual machine management application.

6. A computer-based resource dynamic distribution method being performed by execution of computer readable program code by a processor of a remote server, the remote server in electronic communication with a plurality of cloud servers of a data center, the method comprising:
obtaining a central processing unit (CPU) utilization percentage of each operating system (OS) from each cloud server;
searching the host OS with the CPU utilization percentage exceeding the predetermined CPU utilization percentage for one or more guest OSes with high CPU utilization percentage;
redistributing all of the guest OS in the data center using a knapsack algorithm, if no other host OS is capable of receiving the one or more searched guest OSes; and
transferring the one or more searched guest OSes to other host OS if the other host OS is capable of receiving the one or more searched guest OSes.

7. The method of claim 6, wherein the other host OS is capable of receiving the one or more searched guest OSes upon the condition that a redundancy of the CPU utilization percentage of the other host OS is equal to or greater than a summation of the CPU utilization percentages of the one or more searched guest OSes.

8. The method of claim 7, wherein the redundancy of the CPU utilization percentage of the other host OS is equal to the predetermined CPU utilization percentage minus the CPU utilization percentage of the other host OS.

9. The method of claim 1, wherein the CPU utilization percentage of the host OS is obtained from a virtual machine management application installed in the cloud server.

10. The method of claim 9, wherein the one or more searched guest OSes is transferred using the virtual machine management application.

11. A non-transitory computer-readable medium having stored thereon instructions that, when executed by a remote server, the remote server in electronic communication with a plurality of cloud servers of a data center, causing the remote server to perform a resource dynamic distribution method, the method comprising:
obtaining a central processing unit (CPU) utilization percentage of each operating system (OS) from each cloud server;
searching the host OS with the CPU utilization percentage exceeding the predetermined CPU utilization percentage for one or more guest OSes with high CPU utilization percentage;
redistributing all of the guest OS in the data center using a knapsack algorithm, if no other host OS is capable of receiving the one or more searched guest OSes; and
transferring the one or more searched guest OSes to other host OS if the other host OS is capable of receiving the one or more searched guest OSes.

12. The non-transitory medium of claim 11, wherein the other host OS is capable of receiving the one or more searched guest OSes upon the condition that a redundancy of the CPU utilization percentage of the other host OS is equal to or greater than a summation of the CPU utilization percentages of the one or more searched guest OSes.

13. The non-transitory medium of claim 12, wherein the redundancy of the CPU utilization percentage of the other host OS is equal to the predetermined CPU utilization percentage minus the CPU utilization percentage of the other host OS.

14. The non-transitory medium of claim 11, wherein the CPU utilization percentage of the host OS is obtained from a virtual machine management application installed in the cloud server.

15. The non-transitory medium of claim 14, wherein the one or more searched guest OSes is transferred using the virtual machine management application.
